(19) United States
(12) Patent Application Publication
(10) Pub. No.: US 2023/0419977 A1
(43) Pub. Date: Dec. 28, 2023

(54) AUDIO SIGNAL CONVERSION MODEL LEARNING APPARATUS, AUDIO SIGNAL CONVERSION APPARATUS, AUDIO SIGNAL CONVERSION MODEL LEARNING METHOD AND PROGRAM

(71) Applicant: NIPPON TELEGRAPH AND TELEPHONE CORPORATION, Tokyo (JP)

(72) Inventor: Hirokazu KAMEOKA, Musashino-shi (JP)

(73) Assignee: NIPPON TELEGRAPH AND TELEPHONE CORPORATION, Tokyo (JP)

(21) Appl. No.: 18/033,758

(22) PCT Filed: Nov. 10, 2020
(86) PCT No.: PCT/JP2020/041881

§ 371 Date: Apr. 25, 2023

(51) Int. Cl. G10L 21/013

(52) U.S. Cl. CPC G10L 21/013; G10L 2021/0135

(57) ABSTRACT

A voice signal conversion model learning device including: a data-for-learning acquisition unit that acquires input data for learning that is a voice signal input; a conversion learning model execution unit that executes a conversion learning model that converts the input data for learning into learning stage conversion destination data; and an update unit that updates the conversion learning model by learning, in which: a probability density function is defined as a target feature amount distribution function, the probability density function being a function on a vector space representing a series of voice feature amounts and representing a distribution of a series of voice feature amounts of a target voice signal that is a voice signal having a predetermined attribute; a point is defined as an initial value point, the point being in the vector space and representing a series of feature amounts of the input data for learning; a function is defined as a score function, the function having a point x in the vector space as an independent variable and indicating a gradient of a path from the point x to a stationary point that is on the target feature amount distribution function and is nearest to the initial value point; the conversion learning model execution unit performs conversion of the input data for learning on the basis of the score function; and the update unit updates the score function in updating the conversion learning model.

### TECHNICAL FIELD

The present invention relates to an audio signal conversion model learning apparatus, an audio signal conversion apparatus, an audio signal conversion model learning method and a program.

### BACKGROUND ART

A technology for converting only non-language and paralanguage (such as a speaker characteristic and an utterance style) while holding linguistic information (utterance sentence) of an input voice is called voice quality conversion, and it is expected to apply the technology to speaker characteristic conversion, vocalization support, voice enhancement, pronunciation conversion, and the like of text-to-speech synthesis. As one of technologies of voice quality conversion, for example, use of machine learning has been proposed (Non Patent Literatures 1 and 2).

### CITATION LIST

### Non Patent Literature

Non Patent Literature 1: C.-C. Hsu, H.-T. Hwang, Y.-C. Wu, Y. Tsao, and H.-M. Wang, “Voice conversion from non-parallel corpora using variational auto-encoder,” in Proc. APSIPA, 2016.
Non Patent Literature 2: H. Kameoka, T. Kaneko, K. Tanaka, and N. Hojo, “StarGAN-VC: Non-parallel many-to-many voice conversion using star generative adversarial networks,” in Proc. SLT, 2018, pp. 266-273

### SUMMARY OF INVENTION

### Technical Problem

However, in the case of using the machine learning proposed so far, it has been necessary to prepare a set of a sample of a voice signal of a conversion source and a sample of a voice signal of correct answer data as learning data. Further, it has been necessary that the samples of the two voice signals included in the learning data are samples obtained by reading the same sentence aloud. For example, if the sample of the voice signal of the conversion source is a result of reading a sentence “Good morning” aloud, the sample of the voice signal of the corresponding correct answer data also has to be obtained by reading the sentence “Good morning” aloud. As described above, in the conventional technology, there has been a constraint that both the sample of the voice signal of the conversion source and the sample of the voice signal of the correct answer data need to be obtained by reading the same sentence aloud, with respect to the learning data to be prepared. A target voice is, for example, a voice having a predetermined attribute determined in advance such as an attribute specified by a user.

In view of the above circumstances, an object of the present invention is to provide a technology for relaxing constraints imposed on data used for learning in the technology of voice quality conversion using machine learning.

### Solution to Problem

An aspect of the present invention is a voice signal conversion model learning device including: a data-for-learning acquisition unit that acquires input data for learning, the input data being a voice signal input; a conversion learning model execution unit that executes a conversion learning model that is a model of machine learning that converts the input data for learning into learning stage conversion destination data that is a voice signal of a conversion destination; and an update unit that updates the conversion learning model by learning, in which: a probability density function is defined as a target feature amount distribution function, the probability density function being a function on a vector space representing a series of voice feature amounts that are feature amounts obtained from a voice signal and representing a distribution of a series of voice feature amounts of a target voice signal that is a voice signal having a predetermined attribute; a point is defined as an initial value point, the point being in the vector space and representing a series of feature amounts of the input data for learning; a function is defined as a score function, the function having a point x in the vector space as an independent variable and indicating a gradient of a path from the point x to a nearest stationary point that is a stationary point on the target feature amount distribution function and is a stationary point nearest to the initial value point; the conversion learning model execution unit converts the input data for learning into the learning stage conversion destination data on the basis of the score function; and the update unit updates the score function in updating the conversion learning model.

### Advantageous Effects of Invention

According to the present invention, it is possible to provide a technology for relaxing constraints imposed on data used for learning in the technology of voice quality conversion using machine learning.

### BRIEF DESCRIPTION OF DRAWINGS

FIG. 1 is an explanatory diagram illustrating an outline of a voice signal conversion system 100 of an embodiment.

FIG. 2 is a first explanatory diagram illustrating a conversion learning model in the embodiment.

FIG. 3 is a diagram illustrating an example of processing of sampling in the embodiment.

FIG. 4 is a diagram illustrating an example of a hardware configuration of a voice signal conversion model learning device 1 in the embodiment.

FIG. 5 is a diagram illustrating an example of a functional configuration of a control unit 11 in the embodiment.

FIG. 6 is a diagram illustrating an example of a flow of processing executed by a conversion learning model execution unit 112 in the embodiment.

FIG. 7 is a flowchart illustrating an example of a flow of processing executed by the voice signal conversion model learning device 1 in the embodiment.

FIG. 8 is a diagram illustrating an example of a hardware configuration of a voice signal conversion device 2 in the embodiment.

FIG. 9 is a diagram illustrating an example of a functional configuration of a control unit 21 in the embodiment.

FIG. 10 is a flowchart illustrating an example of a flow of processing executed by the voice signal conversion device 2 in the embodiment.

FIG. 11 is a diagram illustrating a network configuration of a score approximator used in an experiment of the embodiment.

FIG. 12 is a diagram illustrating an example of a result of comparison of MCD under a known speaker condition in the embodiment.

FIG. 13 is a diagram illustrating an example of a result of comparison of MCD under an unknown speaker condition in the embodiment.

FIG. 14 is a diagram illustrating an example of a MOS evaluation result for sound quality in the embodiment.

FIG. 15 is a diagram illustrating an example of a MOS evaluation result for speaker similarity in the embodiment.

### DESCRIPTION OF EMBODIMENTS

### Embodiment

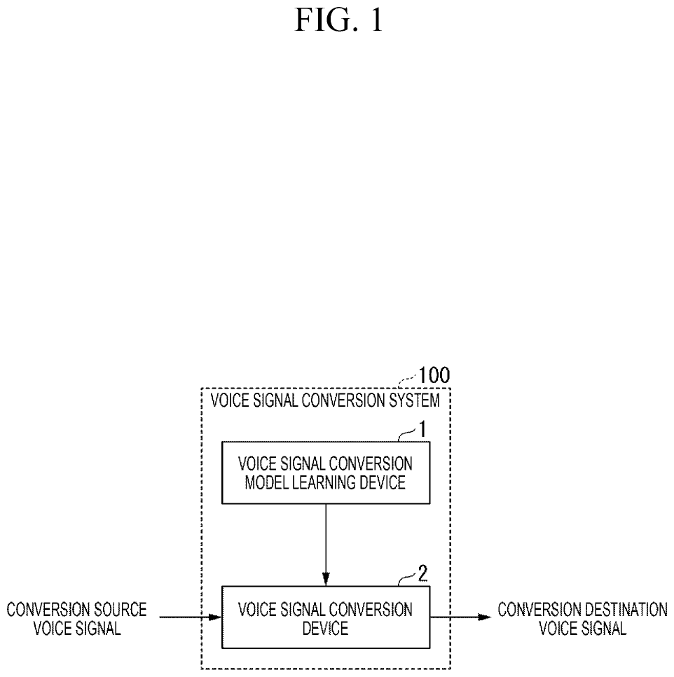

FIG. 1 is an explanatory diagram illustrating an outline of a voice signal conversion system 100 of an embodiment. The voice signal conversion system 100 converts a conversion source voice signal into a voice signal whose sound attribute is a sound attribute of a target voice signal. The voice signal is a signal representing a voice. The conversion source voice signal is a voice signal of a conversion target by the voice signal conversion system 100. The sound attribute is an attribute regarding sound. The sound attribute is, for example, a gender of a speaker. The sound attribute may be, for example, an identifier that identifies the speaker.

The target voice signal is a voice signal having a predetermined sound attribute determined in advance. The predetermined sound attribute is, for example, a sound attribute specified by the user. Hereinafter, the sound attribute of the target voice signal is referred to as a target sound attribute. Hereinafter, a voice signal of a conversion destination of the conversion source voice signal by the voice signal conversion system 100 is referred to as a conversion destination voice signal. For that reason, a sound attribute of the conversion destination voice signal is closer to the target sound attribute than a sound attribute of the conversion source voice signal.

For example, in a case where the target sound attribute is an attribute of a sound uttered by a woman and a conversion source sound attribute is an attribute of a sound uttered by a man, the voice signal conversion system 100 converts a voice signal of a male voice into a voice signal of a female voice. The conversion source sound attribute is a sound attribute of the conversion source voice signal.

Hereinafter, processing of converting the conversion source voice signal into a voice signal having the target sound attribute is referred to as voice signal conversion processing. Specifically, the voice signal conversion processing is processing of executing a voice signal conversion model. The voice signal conversion model is a model of machine learning learned in advance, and is a model of machine learning that converts the conversion source voice signal into the voice signal having the target sound attribute. For that reason, the voice signal conversion model is a result obtained by machine learning and is a learning result by machine learning.

The voice signal conversion system 100 includes a voice signal conversion model learning device 1 and a voice signal conversion device 2. The voice signal conversion model learning device 1 updates a predetermined model of machine learning by machine learning until a predetermined end condition is satisfied. The predetermined model of machine learning at a time point when the predetermined end condition is satisfied is the voice signal conversion model. For that reason, the voice signal conversion model learning device 1 acquires the voice signal conversion model by updating the predetermined model of machine learning by machine learning until the predetermined end condition is satisfied. The voice signal conversion device 2 executes the voice signal conversion processing by using the voice signal conversion model obtained by the voice signal conversion model learning device 1.

Hereinafter, for simplicity of description, performing machine learning is also referred to as learning. In addition, updating the model of machine learning (Hereinafter it is referred to as a “machine learning model”) by machine learning means suitably adjusting a value of a parameter in the machine learning model. In the following description, learning to be A means that the value of the parameter in the machine learning model is adjusted to satisfy A. A represents a condition. In addition, hereinafter, “for learning” means to be used for updating the machine learning model. Note that the model of machine learning is a set including one or a plurality of types of processing in which execution condition and order are determined in advance.

The predetermined model of machine learning updated by the voice signal conversion model learning device 1 (Hereinafter, it is referred to as a “conversion learning model”.) is a model of machine learning that converts an input voice signal. A voice signal that is for learning and is a voice signal of a conversion target (Hereinafter, it is referred to as “input data for learning”.) is input to the conversion learning model. In addition, a voice signal that is for learning and is used for comparison with input data for learning after conversion by the conversion learning model (Hereinafter it is referred to as “reference data for learning”) is input to the conversion learning model. That is, the reference data for learning is so-called correct answer data in machine learning.

Hereinafter, data including a pair of at least one input data for learning and one reference data for learning is referred to as data for learning. That is, the data for learning is data including at least a set of the input data for learning and the reference data for learning, and is an example of so-called learning data.

The conversion learning model converts the input data for learning that has been input into learning stage conversion destination data. The learning stage conversion destination data is a voice signal whose sound attribute is closer to the target sound attribute than that of the input data for learning. The voice signal conversion model learning device 1 updates the conversion learning model on the basis of a difference (Hereinafter it is referred to as “loss”.) between the learning stage conversion destination data and the reference data for learning.

Note that a learned conversion learning model is the voice signal conversion model. That is, the conversion learning model at a time point when the predetermined end condition is satisfied is the voice signal conversion model.

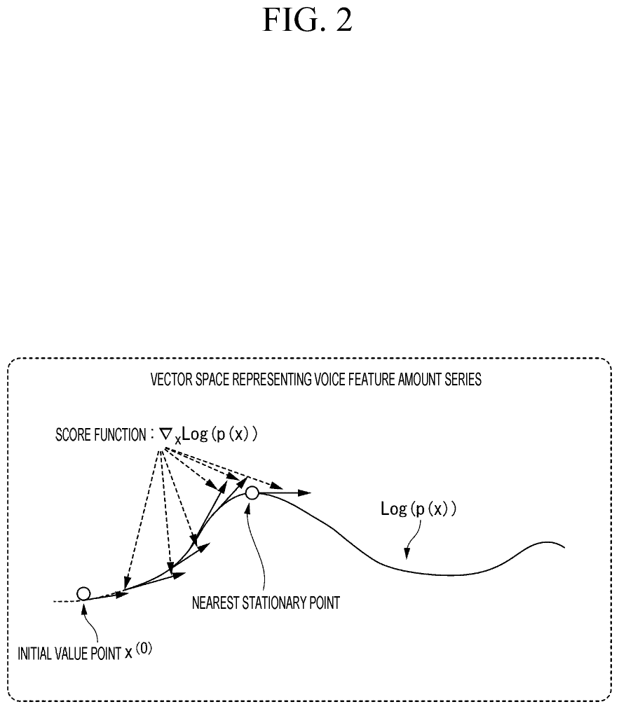

FIG. 2 is an explanatory diagram illustrating the conversion learning model in the embodiment. The conversion learning model includes processing of updating a score function by learning using the data for learning (Hereinafter it is referred to as “score function update processing”.). Note that the conversion learning model is represented by, for example, a neural network. Note that the neural network is a circuit such as an electronic circuit, an electrical circuit, an optical circuit, or an integrated circuit, and is a circuit representing a machine learning model. A parameter of the neural network is suitably adjusted on the basis of the loss, and the parameter of the network is a parameter of the machine learning model to be represented. In addition, the parameter of the network is a parameter of a circuit constituting the network.

Updating the score function means to update a parameter of the neural network representing the score function (Hereinafter, it is referred to as a “score parameter”.). An initial value of the score parameter is in a form given in advance. The score function is a function having a spatial point x as an independent variable, and is a function indicating a gradient at the spatial point x of a path from the spatial point x to a nearest stationary point that is a stationary point on a target feature amount distribution function and is a stationary point nearest to an initial value point. Thus, a value of the score function is a value of the score function at the spatial point x.

The spatial point x is a point in a voice feature amount space. The voice feature amount space is a vector space such as a Banach space or a Sobolev space, and is a vector space representing a series (Hereinafter, the series is referred to as a “voice feature amount series”.) of feature amounts obtained from a voice signal (Hereinafter, the feature amounts are referred to as “voice feature amounts”.). For that reason, the voice feature amount space is a kind of so-called feature amount space. For that reason, the spatial point x is a position in the voice feature amount space and is also data represented as a position x in the voice feature amount space. Specifically, the data represented as the position x of the voice feature amount space is a voice feature amount series.

The target feature amount distribution function is a function on the voice feature amount space and is a probability density function representing a distribution of a series of feature amounts of the target voice signal. The distribution of the series of the feature amounts of the voice signal of the conversion destination is a distribution of the voice feature amount series of the voice signal of the conversion destination. The target feature amount distribution function is continuous and differentiable.

The initial value point is a point in the voice feature amount space (that is, a spatial point) and is a point representing the voice feature amount series of the input data for learning that has been input. The stationary point is, for example, a maximum point.

The score function has a value indicating a gradient of the target feature amount distribution function on a domain of the target feature amount distribution function. The score function has a value of a first-order differentiation of a logarithm of the target feature amount distribution function.

The voice feature amount may be any amount as long as it is sufficient to constitute a voice signal, and may be, for example, a vocoder parameter. The voice feature amount may be, for example, a mel cepstrum vocoder. Another example of the voice feature amount will be described in modifications.

The conversion learning model may be any machine learning model as long as it is a machine learning model having processing of estimating, on the basis of a score function, a stationary point that is on the target feature amount distribution function and is nearest to the initial value point (Hereinafter, the processing is referred to as “nearest stationary point estimation processing”.).

The nearest stationary point estimation processing may be performed by any method as long as the nearest stationary point can be estimated using the score function. The nearest stationary point is estimated, for example, by repeatedly executing in order score function estimation processing such as Denoising Score Matching (DSM) or weighted DSM, and spatial point update processing such as Langevin dynamics or annealed Langevin dynamics. That is, the nearest stationary point estimation processing is, for example, processing of repeatedly executing the score function estimation processing and the spatial point update processing in order to estimate the stationary point. The score function estimation processing is processing of estimating the score function at the spatial point x. The spatial point update processing is processing of updating the spatial point x. Note that the DSM is also referred to as noise elimination score matching.

(Langevin Dynamics, DSM, Weighted DSM, Annealed Langevin Dynamics)

Here, the Langevin dynamics, the DSM, the weighted DSM, and the annealed Langevin dynamics will be described. The Langevin dynamics is, for example, a method described in detail in Reference Literature 1. The DSM is, for example, a method described in detail in Reference Literature 2. The weighted DSM is, for example, a method described in detail in Reference Literature 3. The annealed Langevin dynamics is, for example, a method described in detail in Reference Literature 3.
Reference Literature 1: M. Welling and Y. W. Teh, “Bayesian Learning via Stochastic Gradient Langevin Dynamics,” in Proc. ICML, pp. 681-688, 2011.
Reference Literature 2: P. Vincent, “A Connection Between Score Matching and Denoising Autoencoders,” Neural Computation, Vol 23, No. 7, pp. 1661-1674, 2011.
Reference Literature 3: Y. Song and S. Ermon, “Generative modeling by estimating gradients of the data distribution,” in Advances in Neural Information Processing Systems 32, 2019, pp. 11918-11930

Since details are described in the above-described Reference Literatures, the Langevin dynamics, the DSM, the weighted DSM, and the annealed Langevin dynamics are briefly described here.

First, the Langevin dynamics will be described. The Langevin dynamics is processing of executing an update rule depending on a noise term, and is, for example, processing of repeatedly executing an update rule represented by Formula (1) below so that log p(x) is increased. Among the terms included in Formula (1), the term of Formula (2) is the noise term.

[Math. 1]

x^{(t)}←x^{(t-1)}+α∇ₓ log ρ(x^{(t-1)}+\sqrt{2αz}^{(t)}(t=1, . . . ,T), (1)

[Math. 2]

+\sqrt{2α}z^{(t)} (2)

As described above, the Langevin dynamics represented by Formula (1) is processing of sequentially determining the spatial point x in accordance with the update rule represented by Formula (1). The symbol x^{(t)} means the spatial point x in the t-th step. The symbol x⁽⁰⁾ is the initial value point and is the input data for learning. Note that the number of pieces of the input data for learning does not necessarily have to be one, and may be plural. Hereinafter, a set of the input data for learning is referred to as a learning sample χ. For that reason, the learning sample χ including N pieces of the input data for learning (N is an integer greater than or equal to 1) is represented by Formula (3) below.

[Math. 3]

[symbol]

={xₙ}_{1≤n≤N}

The symbol α means a positive step size parameter. The symbol T represents the number of iterations. The symbol z^{(t)} represents a Gaussian white noise having an average of 0 and a variance of 1. The symbol p(x) represents a contour of the target feature amount distribution function. Formula (4) below included in Formula (1) is an example of the score function.

[Math. 4]

∇ₓ log ρ(x^{(t-1)} (4)

Formula (1) shows that each sample (that is, x^{(T)}) included in a series of x^{(T)} follows p(x) under a predetermined regularity condition in a case where a condition that T is sufficiently large and α is sufficiently small is satisfied. Thus, even in a case where p(x) cannot be estimated, a sample that follows p(x) can be estimated as long as the score function can be estimated. That is, as long as the score function can be estimated, the nearest stationary point can be estimated by the Langevin dynamics. Note that estimating the score function specifically means estimating the value of the score function at each spatial point x.

However, the Langevin dynamics itself is not a method of estimating the score function. For that reason, to determine the nearest stationary point by using the Langevin dynamics, the value of the score function at each spatial point x needs to be estimated by another method.

A DSM method is an example of the method of estimating the score function. The DSM acquires the value of the score function at each spatial point x of the voice feature amount space on the premise that data exists in the entire voice feature amount space. For that reason, by using the Langevin dynamics and the DSM, it is possible to execute processing of estimating the spatial point x of an update destination by the Langevin dynamics using the score function obtained by the DSM.

By the way, many pieces of real world data such as images tend to be localized in a low-dimensional manifold in a high-dimensional space. In such a case, there is the weighted DSM as a method capable of estimating the value of the score function more appropriately than the DSM.

An objective function will be described for the DSM and the weighted DSM. Thus, first, a description will be given of a score approximator commonly used in a method called score matching including the DSM, the weighted DSM, and the like.

The score approximator is a neural network that represents a function including a parameter θ and in which a result of predetermined optimization processing of updating the parameter θ is substantially the same as the score function. The function including the parameter θ and in which the result of the predetermined optimization processing of updating the parameter θ is substantially the same as the score function is a model of machine learning represented by the score approximator.

The predetermined optimization processing is, for example, processing of minimizing an expected value of a square error between a score approximation function s_{θ}(x) and the score function. The score approximation function s_{θ}(x) is a function represented by the score approximator. That is, the score approximation function s_{θ}(x) is the model of machine learning represented by the score approximator. A function representing the expected value of the square error between the score approximation function s_{θ}(x) and the score function is an example of the objective function. That is, a value of the objective function is a loss. Formula (5) below represents an example of the expected value of the square error between the score approximation function s_{θ}(x) and the score function.

[Math. 5]

ε(θ)= [symbol] _{x˜ρ(x)}[∥s_{θ}(x)−∇ₓ log ρ(x)∥₂²]

The symbol E_{x˜p(x)}[·] means an expected value of [·]. The symbol E_{x˜p(x)}[·] is substantially the same as a sample average regarding χ if the number of samples (that is, the input data for learning) included in χ is sufficiently large.

Optimization processing using the objective function of Formula (5) is processing in which it is implicitly assumed that a target value ∇ₓ log p(x) can be observed by some method. On the other hand, there is also a method capable of estimating the score function without assuming a specific form of p(x). One of them is a method called negative score matching described in Reference Literature 4.
Reference Literature 4: A. Hyvarinen, “Estimation of non-normalized statistical models using score matching,” Journal of Machine Learning Research, vol. 6, pp. 695-709, 2005.

Negative score matching is a method utilizing the fact that Formula (5) is equal to Formula (6) below except for constant terms.

[Math. 6]

[symbol]

(θ)= [symbol] _{x˜ρ(x)}[2tr(∇ₓs_{θ}(s))+∥s_{θ}(x)∥₂²] (6)

In Formula (6), ∇ₓs_{θ}(x) represents a Jacobian matrix of s_{θ}(x). The symbol tr(·) represents a trace of the matrix. In this method, the term ∇ₓ log p(x) can be removed from the objective function.

As described above, the score approximator is specifically formed by a neural network.

A network structure of the neural network of the score approximator may be any neural network as long as inputs and outputs have the same form. The score approximator is, for example, a neural network including a normalization layer and a non-linear activation layer. In such a case, the normalization layer may be a batch normalization layer, a conditional batch normalization layer, an instance normalization layer, or a conditional instance normalization layer. The non-linear activation layer may be a normalized linear layer or a gated linear layer.

Then, the objective function in the DSM will be described. The DSM is a method of adding noise according to a predetermined distribution qₒ(x\hat{ } tilde|x) to data of the spatial point x, and then estimating a score function of the distribution qₒ(x\hat{ } tilde) of the data including the noise. Hereinafter, qₒ(x\hat{ } tilde|x) is referred to as a noise distribution. Note that x\hat{ } tilde represents data of the spatial point x to which noise has been added. Note that x\hat{ } tilde represents a symbol in which a tilde is added as an accent symbol to x, and specifically means a symbol represented by Formula (7) below.

[Math. 7]

\tilde{x} (7)

The symbol σ represents a variance of the noise distribution qₒ(x\hat{ } tilde|x). Hereinafter, the variance of the noise distribution is referred to as noise variance. The symbol qₒ(x\hat{ }tilde) is represented by Formula (8) below. For that reason, qₒ(x) is an amount that can be regarded as a Parzen window estimation amount of p(x).

[Math. 8]

q_{σ}(\tilde{x})=∫q_{σ}(\tilde{x}|x)ρ(x)dx (8)

In a case where the noise distribution qₒ(x\hat{ }tilde x) is a Gaussian distribution represented by Formula (9) below, a function represented by Formula (10) below is used as the objective function in the DSM instead of the objective function of Formula (5) or the objective function using Formulas (5) and (6). For that reason, in the DSM, learning of the score approximator representing the score approximation function s_{θ}(x) is performed to minimize the value of the objective function represented by Formula (10).

Hereinafter, for simplicity of description, the score approximator representing the score approximation function s_{θ}(x) is referred to as a score approximator s_{θ}(x). The learning of the score approximator representing the score approximation function s_{θ}(x) means that a model of machine learning represented by the score approximator s_{θ}(x) is updated by learning. For that reason, learning of the score approximator s_{θ}(x) means that the model of machine learning represented by the score approximator s_{θ}(x) is updated by learning.

$$\begin{matrix}[ Math . 9 ] & \\ {q}_{σ} ( \tilde{x} \vert x ) = ( \tilde{x} \vert x , {σ}^{2} I ) & ( 9 )\end{matrix}$$

$$\begin{matrix}[ Math . 10 ] & \\ {σ}_{} ( θ ) = {x ∼ p ( x ) , \tilde{x} ∼ 𝒩 ( \tilde{x} \vert x , {σ}^{2} I )}_{} [ {‖ {s}_{θ} ( \tilde{x} ) - \frac{x - \tilde{x}}{{σ}^{2}} ‖}_{2}^{2} ] & ( 10 )\end{matrix}$$

In the learning of the score approximator s_{θ}(x), s_{θ}(x A tilde) of Formula (10) is updated every time learning is performed. Then, s_{θ}(x\hat{ }tilde) of Formula (10) obtained as a result of the learning of the score approximator s_{θ}(x) is a result of estimation of the score function output by the score approximator s_{θ}(x).

It is known that s_{θ}(x\hat{ }tilde) that minimizes Formula (10) almost reliably matches the score function (see Reference Literature 2). For example, in a case where the square of the variance σ of the noise distribution is sufficiently small and q_{θ}(x) and p(x) are substantially the same as each other, s_{θ}(x\hat{ }tilde) that minimizes Formula (10) is also substantially the same as ∇ₓ log (x). This intuitively means that a direction of a gradient of a logarithmic distribution coincides with a direction toward x before the noise is added at a point x\hat{ }tilde.

The objective function of the weighted DSM will be described. In the weighted DSM, first, the score approximator s_{θ}(x) is learned using a plurality of noise variances represented by Formula (11) below. L in Formula (11) is an integer greater than or equal to l. For that reason, Formula (11) represents a set of L noise variances. Thus, l is an identifier that identifies a noise variance.

[Math. 11]

{σₗ}ₗ₌₁^{L} (11)

In the weighted DSM, an iterative calculation is then executed under an initial condition that a distribution q_{σl}(x) of data covers the entire space of the voice feature amount space. In the iterative calculation of the weighted DSM, a noise variance σₗ is updated to a smaller value for each calculation so that the distribution q_{σl}(x) of the data approaches the true distribution p(x).

In the weighted DSM, since the score approximator s_{θ}(x, l) exists for each noise variance σₗ, a set of the score approximators s_{θ}(x, l) can learn different behaviors depending on the magnitude of the noise variance.

The objective function in the weighted DSM is, for example, a function represented by Formula (12) below.

$$\begin{matrix}[ Math . 12 ] & \\ ℒ ( θ ) = {\sum }_{l = 1}^{L} {λ}_{l} {{σ}_{l}}_{} ( θ ) & ( 12 )\end{matrix}$$

Formula (12) is a weighted linear sum of the objective function of Formula (10) defined for each noise variance σₗ. Note that λₗ is a positive value.

The objective function in the weighted DSM may be, for example, a function represented by Formula (13) below.

$$\begin{matrix}[ Math . 13 ] & \\ ( θ ) = {\sum }_{l = 1}^{L} {x ∼ p ( x ) , \tilde{x} ∼ 𝒩 ( \tilde{x} \vert x , {σ}^{2} I )}_{} [ {‖ {σ}_{l} {s}_{θ} ( \tilde{x} , l ) - \frac{x - \tilde{x}}{{σ}_{l}} ‖}_{2}^{2} ] & ( 13 )\end{matrix}$$

Formula (13) is a function in which the weight λₗ of Formula (12) is replaced with σₗ².

Note that the set of the noise variance σₗ desirably satisfies a relationship of a geometric progression such as (σ₂/θₗ)= . . . =(σ_{L}/σ_{(L-l)})=r (r is a real number greater than or equal to 0 and less than or equal to 1).

As described above, in the weighted DSM, a plurality of objective functions is used having different noise variances σ. Terms of s_{θ}(x, l) of respective objective functions are values corresponding to the noise variance and are not necessarily the same as each other. In the weighted DSM, the score approximators s_{θ}(x, l) are learned using the plurality of objective functions until the predetermined end condition is satisfied and then the variances σ of all the plurality of objective functions are reduced. In the weighted DSM, learning of the score approximator s_{θ}(x, l) is performed using an objective function having a smaller variance σ than at the time of immediately preceding learning until the predetermined end condition is satisfied. In the weighted DSM, accuracy of a result of estimation of the score approximator is increased by repeating the learning of the score approximator s_{θ}(x, l) and reduction of the variance σ in this manner.

Note that, in the iterative calculation executed until the predetermined end condition is satisfied, the initial value of the variance of q_{σl}(x) is a variance in which q_{σl}(x) covers the entire space of the voice feature amount space. The q_{σl}(x) is updated to approach the true distribution p(x) as the iterative calculation proceeds. Specifically, q_{σl}(x) is updated so that the magnitude of the noise variance is reduced as learning progresses.

Since the score function can be estimated after the score approximator s_{θ}(x, l) is learned in this manner, the spatial point x of the update destination can be estimated using the update rule of the spatial point x such as Langevin dynamics. That is, after the score approximator s_{θ}(x, l) is learned in this manner, sampling of samples according to q_{σL} is possible.

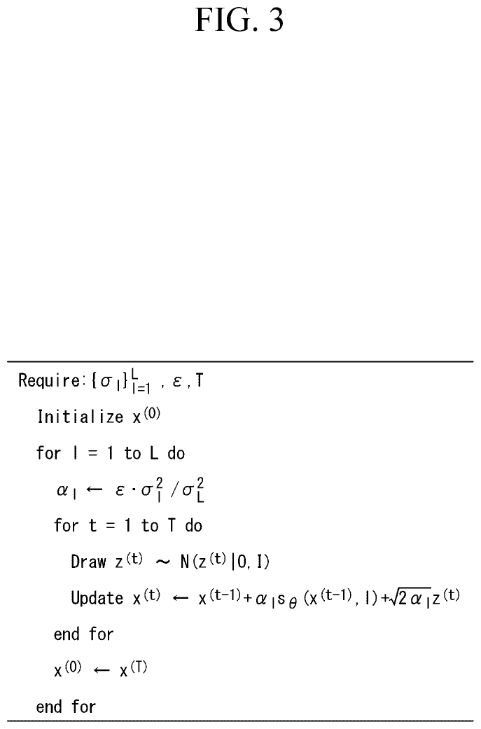

Finally, the annealed Langevin dynamics will be described. The annealed Langevin dynamics is an example of the spatial point update processing. Processing of sampling by the annealed Langevin dynamics is specifically processing of executing an algorithm illustrated in FIG. 3 below.

FIG. 3 is a diagram illustrating an example of processing of sampling in the embodiment. The algorithm in FIG. 3 is an algorithm described in a computer language of Python. The symbol αₗ in FIG. 3 is a step size that adaptively changes depending on the noise variance. The symbol is a scale parameter of αₗ.

In the description of the conversion learning model so far, a description has been given of a case where there is one target sound attribute as an example. In the case where there is one target sound attribute, the learned conversion learning model can convert the input voice signal only into a voice signal having the target sound attribute at the time of learning. However, if learning is performed on a plurality of target sound attributes together with information indicating the target sound attribute (Hereinafter, the information is referred to as “target sound attribute information”.) from the time of learning, the converted conversion learning model can convert the conversion source voice signal into a voice signal of a target sound attribute specified by the user.

Thus, for a case where learning is performed on the plurality of target sound attributes at the time of learning, an example of a learning method will be described using the weighted DSM and the annealed Langevin dynamics as examples.

One of the methods of causing the conversion learning model to be learned for the plurality of target sound attributes is a method using a plurality of score approximators prepared for the respective target sound attributes. In such a case, in a case where the noise distribution is a Gaussian distribution, a function represented by Formula (14) below is used as the objective function.

$$\begin{matrix}[ Math . 14 ] & \\ {ℒ}_{1} ( {θ}_{k} ) = {\sum }_{l = 1}^{L} {x ∼ p ( x ) , \tilde{x} ∼ ( \tilde{x} \vert x , {σ}^{2} I )}_{} [ {‖ {σ}_{l} {s}_{{θ}_{k}} ( \tilde{x} , l ) - \frac{x - \tilde{x}}{{σ}_{l}} ‖}_{2}^{2} ] ( k = 1 , ... , K ) & ( 14 )\end{matrix}$$

The symbol k is an index indicating the target sound attribute (Hereinafter the index is referred to as a “target sound attribute index”.). That is, different symbols k indicate different target sound attributes. The symbol K is an integer greater than or equal to 1 and is the number of target sound attributes to be learned by the conversion learning model. Since the score approximator s_{θ}(x, l) exists for each target sound attribute, score approximators are distinguished from each other by the target sound attribute index in Formula (14). For that reason, in Formula (14), the score approximator is represented as s_{θk}(x, l).

When x_{k, n} is the voice feature amount series of the n-th utterance of the voice signal whose target sound attribute is indicated by k, Ek, x[·] is substantially the same value as the sample average regarding learning data χ={x_{k, n}} including N utterances for each target sound attribute. The x_{k, n} that is an element of the learning data χ is a real matrix of D×M_{k, n}. D represents a dimension of the voice feature amount, and M_{k, n} represents the length of the voice feature amount series. In the x_{k, n} that is the element of the learning data x, k is an integer greater than or equal to 1 and less than or equal to K, and n is an integer greater than or equal to 1 and less than or equal to N. E_{x\hat{ }tilde}[·] is calculated by Monte Carlo approximation.

As described above, Formula (14) represents a sum of differences for the respective score approximators, in which each of the differences is a difference between a value of the spatial point x of the score function and a difference between data of the spatial point x to which noise is added and data of the spatial point x before the noise is added.

Another one of the methods of causing the conversion learning model to be learned for the plurality of target sound attributes is a method of using a single score approximator and causing the single score approximator to be learned so that the score function can be estimated for the plurality of target sound attributes. In such a case, in a case where the noise distribution is a Gaussian distribution, a function represented by Formula (15) below is used as the objective function.

$$\begin{matrix}[ Math . 15 ] & \\ {ℒ}_{2} ( θ ) = {\sum }_{l = 1}^{L} {k ∼ p ( k ) , x ∼ p ( x ) , \tilde{x} ∼ ( \tilde{x} \vert x , {σ}^{2} I )}_{} [ {‖ {σ}_{l} {s}_{θ} ( \tilde{x} , l , k ) - \frac{x - \tilde{x}}{{σ}_{l}} ‖}_{2}^{2} ] ( k = 1 , ... , K ) & ( 15 )\end{matrix}$$

In Formula (15), s e (x, 1, k) represents a score approximator. Also in Formula (15), when x_{k, n} is the voice feature amount series of the n-th utterance of the voice signal whose target sound attribute is indicated by k, E_{k, x}[·] is substantially the same value as the sample average regarding the learning data χ={x_{k, n}} including the N utterances for each target sound attribute. In addition, also in Formula (15), the x_{k, n} that is an element of the learning data χ is a real matrix of D×M_{k, n}, and in the x_{k, n} that is the element of the learning data χ, k is an integer greater than or equal to 1 and less than or equal to K, and n is an integer greater than or equal to 1 and less than or equal to N. Also in Formula (15), E_{x\hat{ } tilde}[·] is calculated by Monte Carlo approximation.

As described above, Formula (15) represents a sum of a plurality of differences included in the single score approximator, in which each of the differences is a difference between a value of the spatial point x of the score function and a difference between data of the spatial point x to which noise is added and data of the spatial point x before the noise is added.

In addition, as described above, both Formulas (14) and (15) represent the sum of the differences, in which each of the differences is a difference between a value of the spatial point x of the score function and a difference between data of the spatial point x to which noise is added and data of the spatial point x before the noise is added. A difference between Formula (14) and Formula (15) is whether only one score approximator is used or score approximators are used for respective target sound attributes in a case where learning is desired to be performed for the plurality of target sound attributes.

Note that, in the case of the weighted DSM, unlike the DSM, the plurality of noise variances is used, and at least one noise variance is different from the other noise variances. For example, as represented in Formula (15), in the weighted DSM using one score approximator, the one score approximator uses a plurality of noise distributions having different noise variances. In addition, as represented in Formula (14), a plurality of noise distributions is used also in the weighted DSM using a plurality of score approximators. Also in the weighted DSM using the plurality of score approximators, noise variances of respective noise distributions are different for respective identifiers l.

As described above, an example of the score function estimation processing is processing of estimating the score function using the noise distribution. In addition, an example of the processing of estimating the score function using the noise distribution is processing of estimating the score function using a plurality of noise distributions at least one of which has a variance different from the others. An example of the processing of estimating the score function using a plurality of noise distributions at least one of which has a variance different from the others is the weighted DSM.

If the score approximator or s_{θ}(x, l) or s_{θ}(x, l, k) can be learned, a correction algorithm is executed with the voice feature amount series of the input voice signal as the initial value point x⁽⁰⁾, whereby the input voice signal is converted into a voice signal having a sound attribute of k. The correction algorithm is the algorithm in FIG. 3 after replacing s_{θ}(x, l) with s_{θk}(x, l) or s_{θ}(x, 1, k). Hereinafter, also the correction algorithm is referred to as the algorithm in FIG. 3 for simplicity of description.

Note that the spatial point update processing is not limited to the update rule of Formula (1), and may be processing of executing an update rule of Formula (16) below.

[Math. 16]

x^{(t)}←x^{(t-1)}+αₗs_{θ}(x^{(t-1)},l) (16)

Hereinafter, the voice signal conversion system 100 will be described with an example in which there are a plurality of target sound attributes at the time of learning of the conversion learning model (that is, a case where K is an integer greater than or equal to 2). For that reason, in the following description, the voice signal conversion system 100 will be described with an example in which the data for learning includes the target sound attribute information. In a case where there is one target sound attribute at the time of learning of the conversion learning model (that is, a case where K is 1), the target sound attribute information in the following description is not necessarily required.

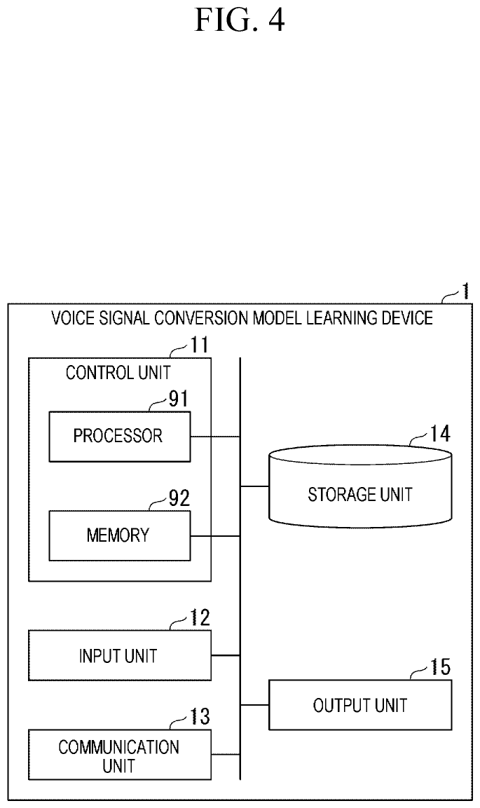

FIG. 4 is a diagram illustrating an example of a hardware configuration of the voice signal conversion model learning device 1 in the embodiment. The voice signal conversion model learning device 1 includes a control unit 11 including a processor 91 such as a CPU and a memory 92 connected to each other via a bus, and executes a program. The voice signal conversion model learning device 1 functions as a device including the control unit 11, an input unit 12, a communication unit 13, a storage unit 14, and an output unit 15 by execution of a program.

More specifically, the processor 91 reads the program stored in the storage unit 14, and stores the read program in the memory 92. The processor 91 executes the program stored in the memory 92, whereby the voice signal conversion model learning device 1 functions as the device including the control unit 11, the input unit 12, the communication unit 13, the storage unit 14, and the output unit 15.

The control unit 11 controls operation of various functional units included in the voice signal conversion model learning device 1. The control unit 11 executes the conversion learning model. Executing the conversion learning model means executing processing included in the conversion learning model and converting the input data for learning into the learning stage conversion destination data. For example, the control unit 11 controls the operation of the output unit 15 and causes the output unit 15 to output a result of execution of the conversion learning model. The control unit 11 records, for example, various types of information generated by execution of the conversion learning model in the storage unit 14. The various types of information stored in the storage unit 14 include, for example, a result of learning of the conversion learning model. The control unit 11 updates the conversion learning model on the basis of the result of execution of the conversion learning model.

The input unit 12 includes an input device such as a mouse, a keyboard, and a touch panel. The input unit 12 may be configured as an interface that connects these input devices to the voice signal conversion model learning device 1. The input unit 12 receives inputs of various types of information to the voice signal conversion model learning device 1. For example, the data for learning is input to the input unit 12.

The communication unit 13 includes a communication interface for connecting the voice signal conversion model learning device 1 to an external device. The communication unit 13 communicates with the external device in a wired or wireless manner. The external device is, for example, a device that is a transmission source of the data for learning.

The storage unit 14 is configured using a non-transitory computer-readable storage medium device such as a magnetic hard disk device or a semiconductor storage device. The storage unit 14 stores various types of information regarding the voice signal conversion model learning device 1. The storage unit 14 stores, for example, information input via the input unit 12 or the communication unit 13. The storage unit 14 stores, for example, the conversion learning model. The storage unit 14 stores, for example, various types of information generated by execution of the conversion learning model.

Note that the data for learning does not necessarily have to be input only to the input unit 12, and does not have to be input only to the communication unit 13. The data for learning may be input from either the input unit 12 or the communication unit 13. For example, the reference data for learning may be input to the input unit 12, and the input data for learning corresponding to the reference data for learning input to the input unit 12 may be input to the communication unit 13. In addition, the data for learning does not necessarily have to be acquired from the input unit 12 or the communication unit 13, and may be stored in the storage unit 14 in advance.

The output unit 15 outputs various types of information. The output unit 15 includes, for example, a display device such as a cathode ray tube (CRT) display, a liquid crystal display, or an organic electro-luminescence (EL) display. The output unit 15 may be configured as an interface that connects these display devices to the voice signal conversion model learning device 1. The output unit 15 outputs, for example, information input to the input unit 12. The output unit 15 may display, for example, the data for learning input to the input unit 12 or the communication unit 13. The output unit 15 may display, for example, the result of execution of the conversion learning model.

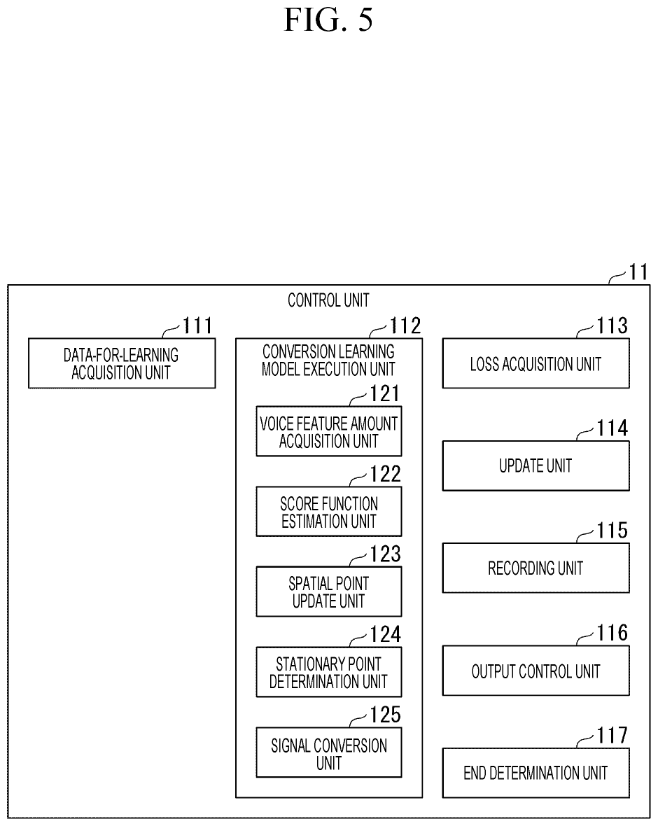

FIG. 5 is a diagram illustrating an example of a functional configuration of the control unit 11 in the embodiment. The control unit 11 includes a data-for-learning acquisition unit 111, a conversion learning model execution unit 112, a loss acquisition unit 113, an update unit 114, a recording unit 115, an output control unit 116, and an end determination unit 117.

The data-for-learning acquisition unit 111 acquires the data for learning input to the input unit 12 or the communication unit 13. In a case where the data for learning is recorded in advance in the storage unit 14, the data-for-learning acquisition unit 111 may read the data for learning from the storage unit 14.

The conversion learning model execution unit 112 executes the conversion learning model to convert the input data for learning into the learning stage conversion destination data. The conversion learning model execution unit 112 may be anything as long as the input data for learning can be converted into the learning stage conversion destination data by executing the conversion learning model. The conversion learning model execution unit 112 is, for example, a neural network representing a learning conversion model. The conversion learning model execution unit 112 is a neural network that includes, for example, a score approximator and represents a learning conversion model. The conversion learning model execution unit 112 includes a voice feature amount acquisition unit 121, a score function estimation unit 122, a spatial point update unit 123, a stationary point determination unit 124, and a signal conversion unit 125.

The voice feature amount acquisition unit 121 acquires the voice feature amount series of the input data for learning acquired by the data-for-learning acquisition unit 111. The score function estimation unit 122 executes the score function estimation processing. The spatial point update unit 123 executes the spatial point update processing. The stationary point determination unit 124 determines whether or not the spatial point x is a stationary point on the target feature amount distribution function. The signal conversion unit 125 executes signal conversion processing.

The signal conversion processing is processing of converting the voice feature amount series into a voice signal on the basis of the voice feature amount series (Hereinafter, the voice feature amount series is referred to as “estimated series”.) represented by the spatial point x determined as the stationary point. Specifically, the signal conversion processing is processing of synthesizing a voice signal from the voice feature amount series by using a vocoder or the like.

Note that, among layers of the neural network, the size of a layer that outputs the estimated series is the same as the size of a layer to which the voice feature amount series of the input data for learning is input.

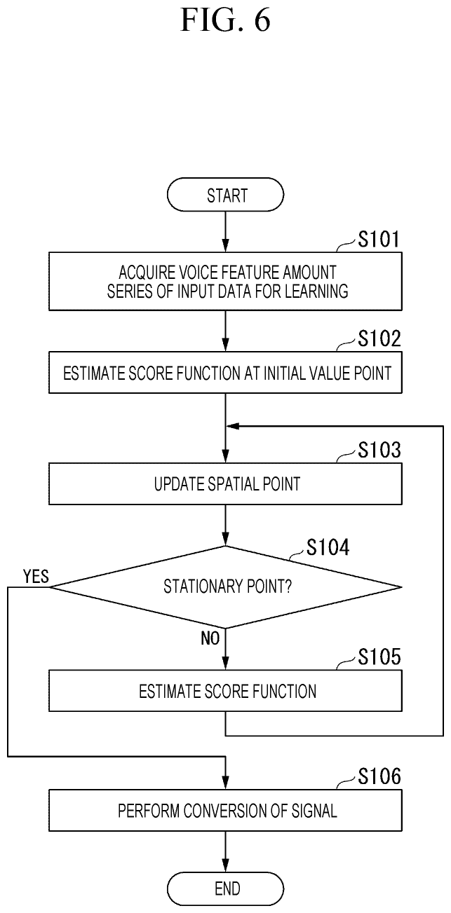

FIG. 6 is a diagram illustrating an example of a flow of processing executed by the conversion learning model execution unit 112 in the embodiment. The voice feature amount acquisition unit 121 acquires the voice feature amount series of the input data for learning (step S101). Next, the score function estimation unit 122 estimates the score function at the initial value point x⁽⁰⁾ by execution of the score function estimation processing using the target sound attribute information with the spatial point indicating the acquired voice feature amount series as the initial value point x⁽⁰⁾ (step S102). The score function estimation processing using the target sound attribute information is the score function estimation processing executed for the target sound attribute indicated by the target sound attribute information, and is, for example, the score function estimation processing using the objective function described in Formula (14) or Formula (15).

Next, the spatial point update unit 123 executes the spatial point update processing using the target sound attribute information on the basis of the score function estimated in the immediately preceding processing, thereby updating the spatial point x (step S103). The spatial point update processing using the target sound attribute information is the spatial point update processing executed for the target sound attribute indicated by the target sound attribute information, and is, for example, the annealed Langevin dynamics.

Next, the stationary point determination unit 124 determines whether or not a position of the spatial point x updated by the processing of step S103 is a stationary point on the target feature amount distribution function (step S104). In a case where it is not the stationary point (step S104: NO), the score function estimation unit 122 estimates the score function at the position of the spatial point x updated by the processing of step S103 by execution of the score function estimation processing using the target sound attribute information (step S105).

On the other hand, in a case where it is the stationary point (step S104: YES), the signal conversion unit 125 executes the signal conversion processing. By execution of the signal conversion processing, the input data for learning is converted into the learning stage conversion destination data (step S106).

The description returns to FIG. 5. The loss acquisition unit 113 acquires a loss on the basis of the learning stage conversion destination data obtained by execution of the conversion learning model and the reference data for learning.

The update unit 114 updates the conversion learning model on the basis of the loss. Specifically, the update of the conversion learning model based on the loss is processing of updating a value of the parameter of the neural network representing the learning conversion model in accordance with a predetermined rule on the basis of the loss. More specifically, the update of the value of the parameter of the neural network representing the learning conversion model is, for example, the update of a value of the parameter θ of the score approximator. For example, the update unit 114 updates the value of the parameter of the neural network representing the learning conversion model to reduce the loss.

The conversion learning model execution unit 112 and the loss acquisition unit 113 may be anything as long as they can execute and update the conversion learning model in cooperation with each other. For example, the conversion learning model execution unit 112 and the loss acquisition unit 113 may be circuits that form a neural network that executes and updates the conversion learning model by operating in cooperation.

The recording unit 115 records various types of information in the storage unit 14. The output control unit 116 controls the operation of the output unit 15. The end determination unit 117 determines whether or not the predetermined end condition is satisfied. The conversion learning model at a time point when the predetermined end condition is satisfied is the learned conversion learning model and the voice signal conversion model.

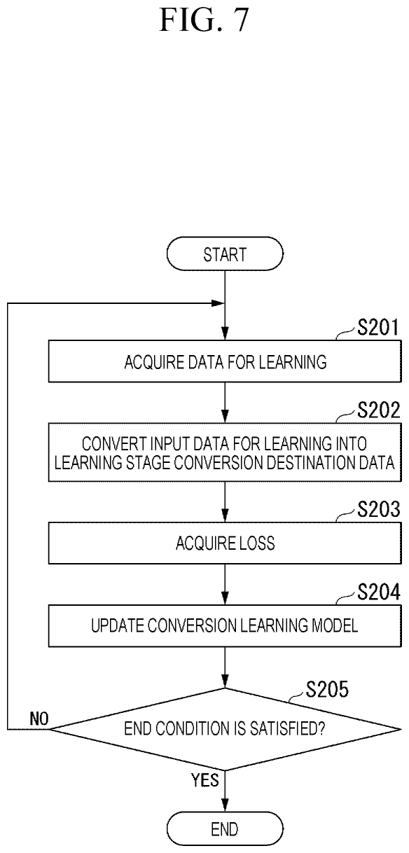

FIG. 7 is a flowchart illustrating an example of a flow of processing executed by the voice signal conversion model learning device 1 in the embodiment.

The data-for-learning acquisition unit 111 acquires the data for learning (step S201). Next, the conversion learning model execution unit 112 executes the processing illustrated in FIG. 6 to convert the input data for learning into the learning stage conversion destination data (step S202). Next, the loss acquisition unit 113 acquires a loss on the basis of the learning stage conversion destination data, and the reference data for learning obtained in step S201 (step S203).

Next, the loss acquisition unit 113 updates the conversion learning model on the basis of the loss (step S204). Next, the end determination unit 117 determines whether or not the predetermined end condition is satisfied (step S205). In a case where the predetermined end condition is not satisfied (step S205: NO), the processing returns to step S201. On the other hand, in a case where the predetermined end condition is satisfied (step S205: YES), the processing ends.

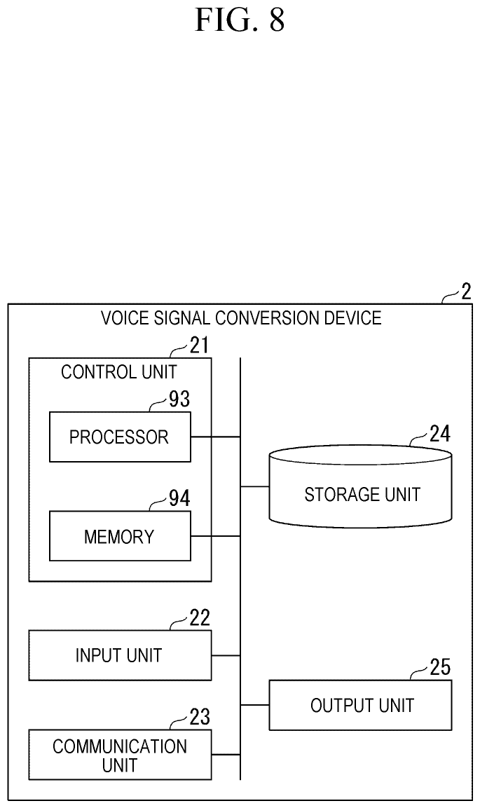

FIG. 8 is a diagram illustrating an example of a hardware configuration of the voice signal conversion device 2 in the embodiment. The voice signal conversion device 2 includes a control unit 21 including a processor 93 such as a CPU and a memory 94 connected to each other via a bus, and executes a program. The voice signal conversion device 2 functions as a device including the control unit 21, an input unit 22, a communication unit 23, a storage unit 24, and an output unit 25 by execution of a program.

More specifically, the processor 93 reads the program stored in the storage unit 24, and stores the read program in the memory 94. The processor 93 executes the program stored in the memory 94, whereby the voice signal conversion device 2 functions as the device including the control unit 21, the input unit 22, the communication unit 23, the storage unit 24, and the output unit 25.

The control unit 21 controls operation of various functional units included in the voice signal conversion device 2. The control unit 21 converts the conversion source voice signal into the conversion destination voice signal having the target sound attribute indicated by the target sound attribute information by using, for example, the learned conversion learning model (that is, the voice signal conversion model) obtained by the voice signal conversion model learning device 1.

The input unit 22 includes an input device such as a mouse, a keyboard, or a touch panel. The input unit 22 may be configured as an interface that connects these input devices to the voice signal conversion device 2. The input unit 22 receives inputs of various types of information to the voice signal conversion device 2. For example, the input unit 22 receives an input that gives an instruction for starting processing of converting the conversion source voice signal into the conversion destination voice signal. The input unit 22 receives, for example, an input of the conversion source voice signal. The input unit 22 receives, for example, an input of the target sound attribute information.

The communication unit 23 includes a communication interface for connecting the voice signal conversion device 2 to an external device. The communication unit 23 communicates with the external device in a wired or wireless manner. The external device is, for example, an output destination of the conversion destination voice signal. In such a case, the communication unit 23 outputs the conversion destination voice signal to the external device by communication with the external device. The external device at the time of outputting the conversion destination voice signal is, for example, a voice output device such as a speaker.

The external device of a communication destination of the communication unit 23 is, for example, the voice signal conversion model learning device 1. In such a case, the communication unit 23 acquires, for example, the learned conversion learning model obtained by the voice signal conversion model learning device 1.

The external device of the communication destination of the communication unit 23 may be, for example, a storage device such as a USB memory storing the voice signal conversion model. In a case where the external device stores, for example, the voice signal conversion model and outputs the voice signal conversion model, the communication unit 23 acquires the voice signal conversion model by communication with the external device.

The external device of the communication destination of the communication unit 23 is, for example, an output source of the conversion source voice signal. In such a case, the communication unit 23 acquires the conversion source voice signal from the external device by communication with the external device.

Note that the communication unit 23 may acquire the conversion source voice signal and the target sound attribute information by communicating with the external device that is a transmission source of the conversion source voice signal and the target sound attribute information.

The storage unit 24 is configured using a non-transitory computer-readable storage medium device such as a magnetic hard disk device or a semiconductor storage device. The storage unit 24 stores various types of information regarding the voice signal conversion device 2. The storage unit 24 stores, for example, the voice signal conversion model acquired via the communication unit 23. The storage unit 24 stores, for example, the target sound attribute information input to the input unit 22.

The output unit 25 outputs various types of information. The output unit 25 includes, for example, a display device such as a CRT display, a liquid crystal display, or an organic EL display. The output unit 25 may be configured as an interface that connects these display devices to the voice signal conversion device 2. The output unit 25 outputs, for example, information input to the input unit 22.

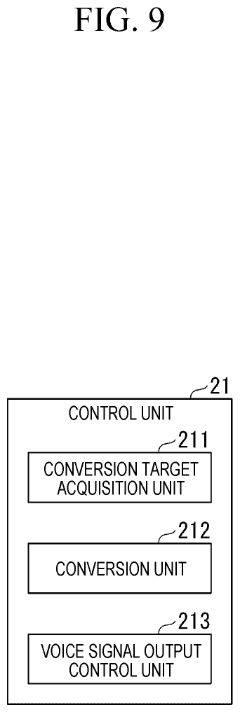

FIG. 9 is a diagram illustrating an example of a functional configuration of the control unit 21 in the embodiment. The control unit 21 includes a conversion target acquisition unit 211, a conversion unit 212, and a voice signal output control unit 213.

The conversion target acquisition unit 211 acquires the conversion source voice signal to be a conversion target and the target sound attribute information. The conversion target acquisition unit 211 acquires, for example, the conversion source voice signal and the target sound attribute information input to the input unit 22. The conversion target acquisition unit 211 acquires, for example, the conversion source voice signal and the target sound attribute information input to the communication unit 23.

The conversion unit 212 converts the conversion target acquired by the conversion target acquisition unit 211 into a conversion destination voice signal having a sound attribute indicated by the target sound attribute information by using the voice signal conversion model. The obtained conversion destination voice signal is output to the voice signal output control unit 213.

The voice signal output control unit 213 controls the operation of the communication unit 23. The voice signal output control unit 213 controls the operation of the communication unit 23 to cause the communication unit 23 to output the conversion destination voice signal.

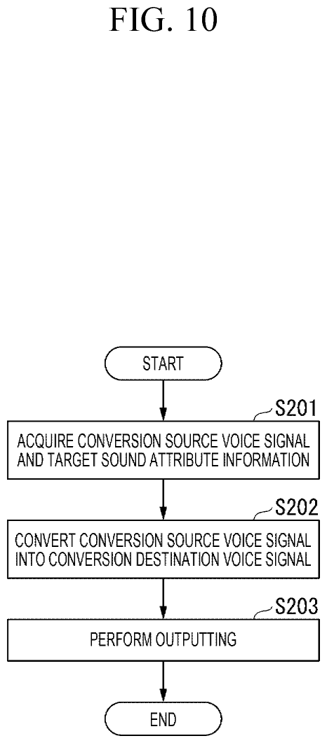

FIG. 10 is a flowchart illustrating an example of a flow of processing executed by the voice signal conversion device 2 in the embodiment. The conversion target acquisition unit 211 acquires the conversion source voice signal and the target sound attribute information (step S201). Next, the conversion unit 212 converts the conversion source voice signal into the conversion destination voice signal having the sound attribute indicated by the target sound attribute information by using the voice signal conversion model (step S202). Next, the voice signal output control unit 213 controls the operation of the communication unit 23 to cause the communication unit 23 to output the conversion destination voice signal (step S203).

Note that, as described above, in a case where there is one target sound attribute at the time of learning of the conversion learning model, the target sound attribute information does not necessarily have to be input to the voice signal conversion device 2.

(Experimental Results)

A description will be given of an example of an experimental result of conversion of a voice signal using the voice signal conversion system 100 of the embodiment. In the experiment, the sound attribute was a speaker. Thus, hereinafter, an index indicating the target sound attribute in the experiment is referred to as a speaker index.

In the experiment, voice data of six speakers of CMU ARCTIC database was used. Specifically, voice data of four speakers was used for learning and for a test assuming known speakers, and voice data of two speakers was used exclusively for a test assuming unknown speakers. The four speakers for learning and for the test assuming known speakers were a female speaker clb, a male speaker bdl, a female speaker slt, and a male speaker rms. The two speakers exclusively for the test assuming unknown speakers were a male speaker ksp and a female speaker lnh.

As described above, since the number of speakers used for learning in the experiment was four, the dimension of a one-hot vector representing the speaker index was four. The CMU ARCTIC database is a database of voice samples of a plurality of speakers, and each voice sample is a voice sample of a voice in which the speaker utters the same 1132 sentences regardless of the speaker.

In the experiment, voice samples of each speaker of 132 sentences in the latter half of the 1132 sentences uttered by the speaker were used as test data. In addition, in the experiment, to simulate a situation of non-parallel learning, 1000 sentences in the first half were further divided into four equal parts so that samples of the same sentence are not used among the speakers, and used as voice samples for learning of the speakers clb, bdl, slt, and rms. That is, groups obtained as a result of equally dividing the 1000 sentences in the first half into four were respectively defined as a first group, a second group, a third group, and a fourth group, and the voice samples for learning of the speakers clb, bdl, slt, and rms were sentences of the first group, sentences of the second group, sentences of the third group, and sentences of the fourth group in order. Note that the voice samples for learning are examples of the data for learning.

In the experiment, a sampling frequency of all voice signals was 16000 Hz. In the experiment, the voice feature amount was a mel cepstrum coefficient. The mel cepstrum coefficient was obtained by extracting a spectral envelope, a fundamental frequency (F0), and an aperiodic index at intervals of 8 ms by WORLD analysis for each utterance, and then performing 28th order mel cepstrum analysis on the extracted spectral envelope series. Thus, D=28.

Regarding F0, first, an average m_{src} and a standard deviation σ_{src} of a logarithm F0 in a voiced section were calculated from the learning data of the target voice, and an average m_{trg} and the standard deviation σ_{src} of the logarithm F0 in the voiced section were calculated from the learning data of the conversion source voice. Next, conversion represented by Formula (17) below was performed on a logarithmic F0 pattern y(0) . . . y (N−1) of an input voice. Note that the target voice is a voice whose voice signal is the target voice signal. In the conversion source voice, the voice signal is a voice of the conversion source voice signal.

$$\begin{matrix}[ Math . 17 ] & \\ \hat{y} ( n ) = \frac{{σ}_{trg}}{{σ}_{src}} ( y ( n ) - {m}_{src} ) + {m}_{trg} & ( 17 )\end{matrix}$$

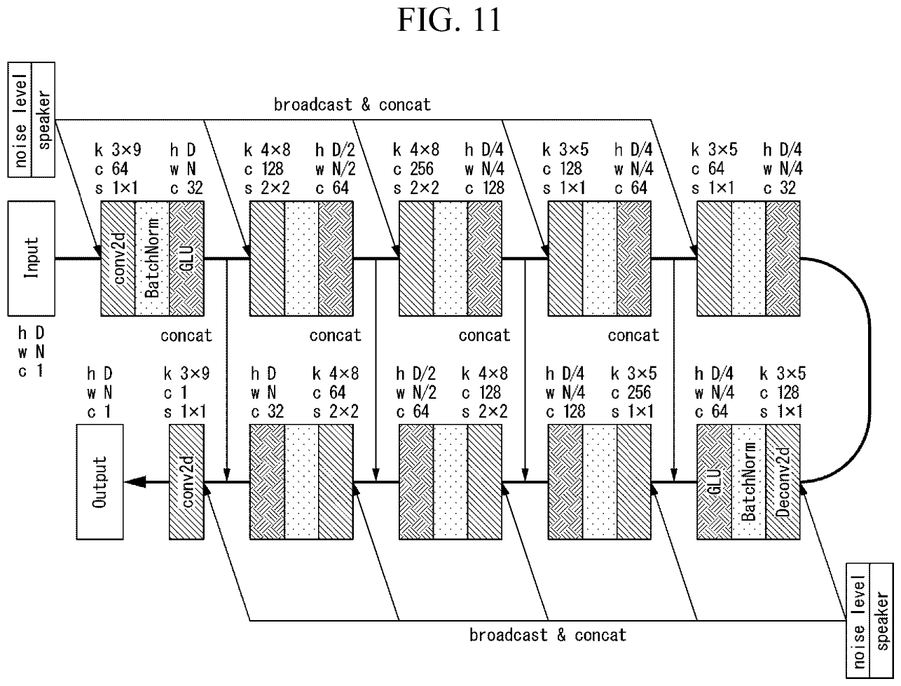

FIG. 11 is a diagram illustrating a network configuration of the score approximator used in the experiment of the embodiment. That is, the network configuration of FIG. 11 is an example of the network configuration of the score approximator. In FIG. 11, “h”, “w”, and “c” of “hwc” respectively represent the height, the width, and the number of channels when an input/output of each layer is regarded as an image. In FIG. 11, “Conv2d”, “BatchNorm”, “GLU”, and “Deconv2d” represent a two-dimensional convolution layer, a normalization layer, a non-linear activation layer, and a two-dimensional transposed convolution layer, respectively. In FIG. 11, “k”, “c”, and “s” of “kcs” represent the kernel size, the number of output channels, and the stride width of a convolution layer, respectively. The noise variance and the speaker index each are represented by one-hot vector, and, when an input in each convolution layer is regarded as an image, are connected in a channel direction to each pixel of the input. In the network configuration of FIG. 11, “Input” and “Output” have the same form.

Hyperparameters in the experiment were as follows. First, Adam was used for learning of the neural network. The learning rate was 0.001. Noise variances σₗ to σ_{L} (integers greater than or equal to L1) were (σ₂/σₗ)= . . . =(σ_{L}/σ_{(L-1)})=10^{-0.2} to 0.63, L=11, σₗ=1:0, and σ_{L}=0.01. In the experiment, the algorithm in FIG. 3 was used. When the algorithm in FIG. 3 was used in the experiment, ε=10⁻⁵ and T=120. In the experiment, l=4 was used as the initial value of the noise variance in the algorithm in FIG. 3.

A method based on a variational autoencoder (VAE) (Hereinafter, the method is referred to as “VAE-VC”.) and a method based on StarGAN that is a variation of a generative adversarial network (GAN) (Hereinafter, the method is referred to as “StarGAN-VC”.) are methods that allow non-parallel learning and voice input of any speaker among conventional methods. Thus, in the experiment, VAE-VC and StarGAN-VC were used as baselines to be compared.

There are several types of StarGAN-VC depending on the objective function. In the experiment, StarGAN-VC using a cross entropy criterion (Hereinafter, it is referred to as “StarGAN-VC(C)”.) and StarGAN-VC using a Wasserstein distance and a gradient penalty loss (Hereinafter, it is referred to as “StarGAN-VC(W)”.) were used as the baselines.

Since a test set includes a voice sample in which each speaker utters the same sentence, quality of a converted voice can be evaluated by comparison with a voice of a target speaker who has uttered the same sentence. The converted voice is a voice signal converted by the voice signal conversion system 100. That is, the converted voice is a voice of which the voice signal is the conversion destination voice signal or a voice of which the voice signal is the learning stage conversion destination data. The target speaker is a speaker of the target voice.

Mel-cepstral distortion (MCD) when two sets of mel cepstrums represented by Formulas (18) and (19) below are given is represented by Formula (20) below. MCD represents a difference between the two sets of mel cepstrums represented by Formulas (18) and (19).

$$\begin{matrix}[ Math . 18 ] & \\ {[ {\hat{x}}_{1} , ... , {\hat{x}}_{D} ]}^{T} & ( 18 )\end{matrix}$$

$$\begin{matrix}[ Math . 19 ] & \\ {[ {x}_{1} , ... , {x}_{D} ]}^{T} & ( 19 )\end{matrix}$$

$$\begin{matrix}[ Math . 20 ] & \\ MCD [ dB ] = \frac{10}{ln 10} \sqrt{2 {\sum }_{d = 2}^{D} {( {\hat{x}}_{d} - {x}_{d} )}^{2}} & ( 20 )\end{matrix}$$

Phonemes of the converted voice and the target voice do not necessarily correspond to each other at the same time. For that reason, in the experiment, the time axes were aligned by dynamic time warping (DTW) with an MCS criterion for each utterance, and then an average MCD was calculated.

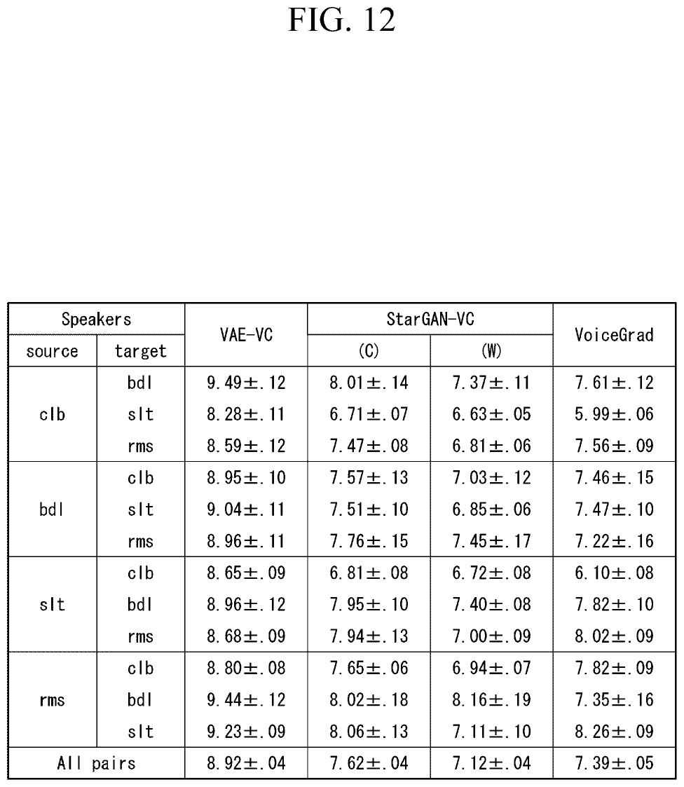

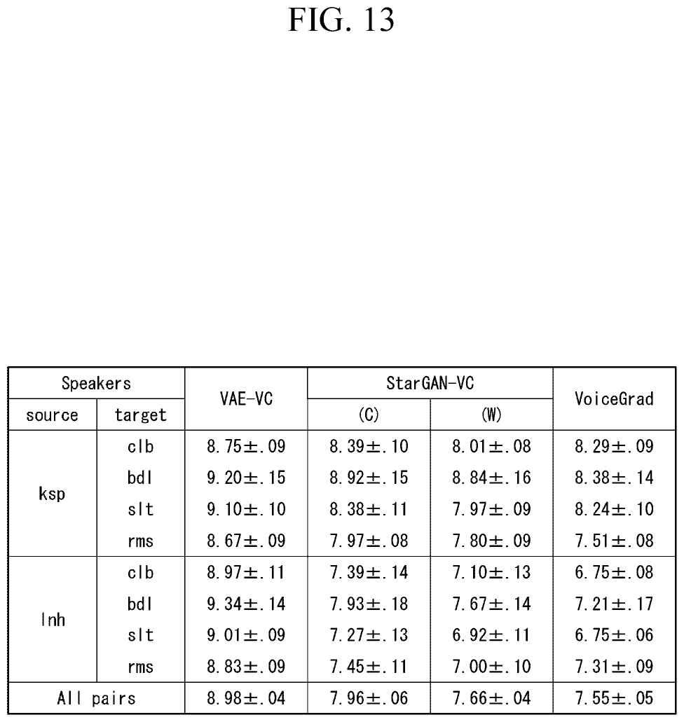

In the experiment, an objective evaluation experiment was performed. FIGS. 12 and 13 illustrate examples of results of the objective evaluation experiment. Specifically, FIG. 12 is an example of a result of comparison of MCD under a known speaker condition, and FIG. 13 is an example of a result of comparison of MCD under an unknown speaker condition. The known speaker condition is a condition that a speaker of a voice signal input to the voice signal conversion device 2 is included in the data for learning. The unknown speaker condition is a condition that a speaker of a voice signal input to the voice signal conversion device 2 is not included in the data for learning.

FIG. 12 is a diagram illustrating an example of a result of comparison of MCD under the known speaker condition in the embodiment. In FIG. 12, “VoiceGrad” indicates conversion of a voice signal using the voice signal conversion system 100. FIG. 12 illustrates that a method of conversion of a voice signal using the voice signal conversion system 100 has higher performance than the VAE-VC and the StarGAN-VC(C), under the known speaker condition.

FIG. 13 is a diagram illustrating an example of a result of comparison of MCD under the unknown speaker condition in the embodiment. In FIG. 13, “VoiceGrad” indicates conversion of a voice signal using the voice signal conversion system 100. FIG. 13 illustrates that the method of conversion of a voice signal using the voice signal conversion system 100 has higher performance than methods of all the baselines to be compared, under the unknown speaker condition.

In the experiment, a subjective evaluation experiment by a mean opinion score (MOS) of sound quality and speaker similarity was also performed. The subjective evaluation experiment was performed only on samples of converted voice under the unknown speaker condition. There were 24 participants in each subjective evaluation experiment.

In the evaluation of the sound quality in the subjective evaluation experiment, the participants were asked to listen to a sample randomly selected from a sample of a non-vocoder voice and a sample of a vocoder voice, and the level of the sound quality was evaluated on a scale of 5. The non-vocoder voice is a converted voice generated by using VAE-VC, StarGAN-VC(C), StarGAN-VC(W), and VoiceGrad. The vocoder voice is a synthesized voice obtained by analyzing and synthesizing a real voice with a vocoder. The quality of the vocoder voice is an upper limit quality within constraints using the vocoder.

In addition, in the experiment, an experiment for speaker similarity evaluation was also performed. In the experiment for speaker similarity evaluation, the participants were asked to continuously listen to a sample randomly selected from a sample of a non-vocoder voice and a sample of a vocoder voice, and a real voice sample of the target speaker. Then, the participants were asked to evaluate whether or not both voices seem to have been uttered by the same speaker on a scale of 5.

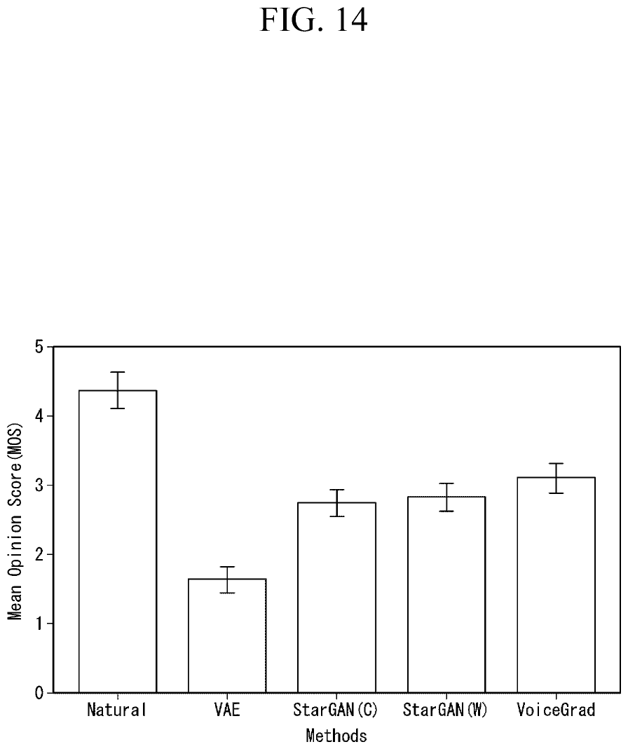

FIG. 14 is a diagram illustrating an example of a MOS evaluation result for sound quality in the embodiment. In FIG. 14, the numbers 1 to 5 on the vertical axis represent MOS, and the larger the number, the better the sound quality is evaluated. More specifically, 5 is Excellent, 4 is Good, 3 is Fair, 2 is Poor, and 1 is Bad. In FIG. 14, “VoiceGrad” indicates conversion of a voice signal using the voice signal conversion system 100. FIG. 14 illustrates that the method of conversion of a voice signal using the voice signal conversion system 100 has obtained a higher evaluation for the sound quality than methods of all the baselines to be compared.

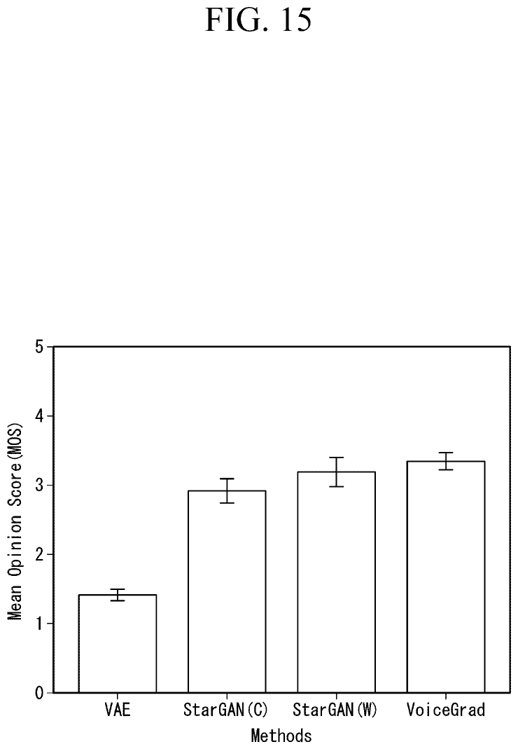

FIG. 15 is a diagram illustrating an example of a MOS evaluation result for speaker similarity in the embodiment. In FIG. 15, the numbers 1 to 5 on the vertical axis represent MOS, and the larger the number, the better the sound quality is evaluated. More specifically, 5 is Denitely, 4 is Likely, 3 is Fair, 2 is Not very likely, and 1 is Unlikely. In FIG. 15, “VoiceGrad” indicates conversion of a voice signal using the voice signal conversion system 100. FIG. 15 illustrates that the method of conversion of a voice signal using the voice signal conversion system 100 has obtained a higher evaluation for the speaker similarity than methods of all the baselines to be compared.

The voice signal conversion model learning device 1 of the embodiment configured as described above estimates the value of the score function of the spatial point x, and estimates the nearest stationary point on the basis of the estimated value of the score function. As described above, the voice signal conversion model learning device 1 does not necessarily have to acquire the form of the target feature amount distribution function p(x) in advance as prior information at the time of learning. For that reason, the voice signal conversion model learning device 1 can relax constraints imposed on data used for learning in the technology of voice quality conversion using machine learning.

In addition, since a stationary point of a target feature amount series distribution does not depend on a feature amount series distribution of an input voice, the above method is theoretically applicable to an input voice by any speaker.

In addition, the voice signal conversion system 100 of the embodiment configured as described above includes the voice signal conversion model learning device 1. For that reason, the voice signal conversion model learning device 1 can relax constraints imposed on data used for learning in the technology of voice quality conversion using machine learning.

### Modifications

In a case where the mel cepstrum vocoder is used as the voice feature amount, the voice signal can be synthesized from the mel cepstrum coefficient, the fundamental frequency (F0) value, and the aperiodic index for each short section. For that reason, a vector obtained by combining these may be used as the voice feature amount. In addition, a method of performing conversion of an F0 pattern that is a series of F0 values may be a method of executing shifting and scaling so that the average and variance of logarithmic F0 values match those of the target speaker. In addition, since the aperiodic index of the input voice can be used as it is without conversion, the voice feature amount may be only the mel cepstrum coefficient. Note that, in the above-described experiment, a vector with the mel cepstrum coefficient as an element is used as the voice feature amount.

In addition, the voice feature amount may be a feature amount assuming that a high-quality neural vocoder such as WaveNet is used. In the high-quality neural vocoder such as WaveNet, a mel spectrum for each short section is used as a feature amount. For that reason, the feature amount assuming the high-quality neural vocoder is, for example, a mel spectrum.

In a case where the mel cepstrum coefficient is used as the voice feature amount, if the mel cepstrum coefficient in a d-th dimensional short time frame m is represented as x_{d, m}, it is possible to use, as an input, one normalized by Formula (21) below in learning and a test. Hereinafter, the normalized mel cepstrum coefficient is referred to as a normalized mel cepstrum coefficient.

[Math. 21]

x_{d,m}←(x_{d,m}−ψ_{d})/ζ_{d} (21)

The symbol ψ_{d} represents an average of the d-th dimensional mel cepstrum coefficients in the voiced section. The symbol ξ_{d} represents a standard deviation of the d-th dimensional mel cepstrum coefficients in the voiced section. In the case of using such normalized mel cepstrum coefficient, in the test, the average and the standard deviation of the feature amount series finally generated by the algorithm in FIG. 3 are adjusted to match those of the target speaker by using appropriate shifting and scaling. Note that the test means using a learned machine learning model.

Note that, in a method that is one of methods of causing the conversion learning model to be learned for a plurality of target sound attributes and uses a plurality of score approximators prepared for each target sound attribute, the noise distribution does not necessarily have to be a Gaussian distribution, and may be another distribution such as a Laplacian distribution. In addition, also in a method that causes the conversion learning model to be learned for a plurality of target sound attributes and is another one method described above, the noise distribution does not necessarily have to be a Gaussian distribution, and may be another distribution such as a Laplacian distribution. Note that the another one method described above is a method of using a single score approximator and causing the single score approximator to be learned so that the score function can be estimated for the plurality of target sound attributes.

Note that, in the method of estimating the score function, the accuracy of estimation is higher in the case of using the weighted DSM than in the case of the DSM. This is because the DSM performs estimation using a distribution of a single variance, whereas the weighted DSM performs estimation using a plurality of distributions having different variances. That is, since the weighted DSM uses a plurality of noise distributions having different noise variances σ, the accuracy of estimation of the score function is higher than that of the DSM using a single noise distribution.

The voice signal conversion model learning device 1 may be implemented by using a plurality of information processing devices communicably connected to each other via a network. In this case, the functional units included in the voice signal conversion model learning device 1 may be implemented in a distributed manner in the plurality of information processing devices.

The voice signal conversion device 2 may be implemented by using a plurality of information processing devices communicably connected to each other via a network. In this case, the functional units included in the voice signal conversion device 2 may be implemented in a distributed manner in the plurality of information processing devices.

Note that, all or some of the functions of the voice signal conversion system 100 may be implemented using hardware such as an application specific integrated circuit (ASIC), a programmable logic device (PLD), or a field programmable gate array (FPGA). The program may be recorded on a computer-readable recording medium. The computer-readable recording medium is a storage device such as, for example, a flexible disk, a magneto-optical disk, a read-only memory (ROM), a portable medium such as a compact disc read-only memory (CD-ROM), or a hard disk built in a computer system. The program may be transmitted via an electrical communication line.

Although the embodiment of the present invention has been described in detail with reference to the drawings so far, a specific configuration is not limited to this embodiment, and includes a design and the like without departing from the scope of the present invention.

### REFERENCE SIGNS LIST

100 voice signal conversion system
1 voice signal conversion model learning device
2 voice signal conversion device
11 control unit
12 input unit
13 communication unit
14 storage unit
15 output unit
111 data-for-learning acquisition unit
112 conversion learning model execution unit
121 voice feature amount acquisition unit
122 score function estimation unit
123 spatial point update unit
124 stationary point determination unit
125 signal conversion unit
113 loss acquisition unit
114 update unit
115 recording unit
116 output control unit
117 end determination unit
21 control unit
22 input unit
23 communication unit
24 storage unit
25 output unit
211 conversion target acquisition unit
212 conversion unit
213 voice signal output control unit
91 processor
92 memory
93 processor
94 memory

1. A voice signal conversion model learning device comprising:
a processor; and
a storage medium having computer program instructions stored thereon, wherein the computer program instruction, when executed by the processor, perform processing of:
acquiring input data for learning, the input data being a voice signal input;
executing a conversion learning model that is a model of machine learning that converts the input data for learning into learning stage conversion destination data that is a voice signal of a conversion destination; and
updating the conversion learning model by learning,
wherein
a probability density function is defined as a target feature amount distribution function, the probability density function being a function on a vector space representing a series of voice feature amounts that are feature amounts obtained from a voice signal and representing a distribution of a series of voice feature amounts of a target voice signal that is a voice signal having a predetermined attribute,
a point is defined as an initial value point, the point being in the vector space and representing a series of feature amounts of the input data for learning,
a function is defined as a score function, the function having a point x in the vector space as an independent variable and indicating a gradient of a path from the point x to a nearest stationary point that is a stationary point on the target feature amount distribution function and is a stationary point nearest to the initial value point,
the input data for learning is converted into the learning stage conversion destination data on a basis of the score function in the executing, and
the score function in updating the conversion learning model in the updating.

2. The voice signal conversion model learning device according to claim 1, wherein
a neural network is defined as a score approximator, the neural network representing a function that includes a parameter θ and in which a result of predetermined optimization processing of updating the parameter θ is substantially identical to a score function,
a neural network representing the conversion learning model includes a plurality of the score approximators, and
the score function is updated in the updating on a basis of a sum of differences for the respective score approximators, wherein each of the differences is a difference between a value of the score function and a difference between data of the point x to which noise is added and data of the point x of the space before the noise is added.

3. The voice signal conversion model learning device according to claim 2, wherein
a method for updating the score function on a basis of the sum is weighted Denoising Score Matching (DSM).

4. The voice signal conversion model learning device according to claim 1, wherein
a neural network is defined as a score approximator, the neural network representing a function that includes a parameter θ and in which a result of predetermined optimization processing of updating the parameter θ is substantially identical to a score function,
a neural network representing the conversion learning model includes a single piece of the score approximator, and
the score function is updated in the updating on a basis of a sum of a plurality of differences included in the score approximator, wherein each of the differences is a difference between a value of the score function and a difference between data of the point x to which noise is added and data of the point x of the space before the noise is added.

5. A voice signal conversion device comprising:
a processor; and
a storage medium having computer program instructions stored thereon, wherein the computer program instruction, when executed by the processor, perform processing of:
acquiring a voice signal of a conversion target; and
performing conversion of the conversion target by using a learned conversion learning model obtained by a voice signal conversion model learning device comprising: a processor; and a storage medium having computer program instructions stored thereon, wherein the computer program instruction, when executed by the processor, perform processing of: acquiring input data for learning, the input data being a voice signal input; executing a conversion learning model that is a model of machine learning that converts the input data for learning into learning stage conversion destination data that is a voice signal of a conversion destination; and updating the conversion learning model by learning, wherein a probability density function is defined as a target feature amount distribution function, the probability density function being a function on a vector space representing a series of voice feature amounts that are feature amounts obtained from a voice signal and representing a distribution of a series of voice feature amounts of a target voice signal that is a voice signal having a predetermined attribute, a point is defined as an initial value point, the point being in the vector space and representing a series of feature amounts of the input data for learning, a function is defined as a score function, the function having a point x in the vector space as an independent variable and indicating a gradient of a path from the point x to a nearest stationary point that is a stationary point on the target feature amount distribution function and is a stationary point nearest to the initial value point, the input data for learning is converted into the learning stage conversion destination data on a basis of the score function in the executing, and the score function in updating the conversion learning model in the updating.

6. A voice signal conversion model learning method comprising:
acquiring input data for learning, the input data being a voice signal input;
executing a conversion learning model that is a model of machine learning that converts the input data for learning into learning stage conversion destination data that is a voice signal of a conversion destination; and
updating the conversion learning model by learning,
wherein
a probability density function is defined as a target feature amount distribution function, the probability density function being a function on a vector space representing a series of voice feature amounts that are feature amounts obtained from a voice signal and representing a distribution of a series of voice feature amounts of a target voice signal that is a voice signal having a predetermined attribute,
a point is defined as an initial value point, the point being in the vector space and representing a series of feature amounts of the input data for learning,
a function is defined as a score function, the function having a point x in the vector space as an independent variable and indicating a gradient of a path from the point x to a nearest stationary point that is a stationary point on the target feature amount distribution function and is a stationary point nearest to the initial value point,
in the executing, the input data for learning is converted into the learning stage conversion destination data on a basis of the score function, and
in the updating, the score function is updated in updating the conversion learning model.

7. A non-transitory computer readable medium which stores a program for causing a computer to function as the voice signal conversion model learning device according to claim 1.
